(19) United States
(12) Patent Application Publication
(10) Pub. No.: US 2018/0281252 A1
(43) Pub. Date: Oct. 4, 2018

(54) ROTARY VALVE

(71) Applicant: Synventive Molding Solutions, Inc., Peabody, MA (US)

(72) Inventor: Vito GALATI, Rowley, MA (US)

(21) Appl. No.: 15/985,090

(22) Filed: May 21, 2018

Related U.S. Application Data
(63) Continuation of application No. PCT/US2018/025352, filed on Mar. 18, 2018.
(60) Provisional application No. 62/479,505, filed on Mar. 31, 2017.

(51) Int. Cl. B29C 45/28; B29C 45/17; B29C 45/77; B29C 45/23; B29C 45/80

(52) U.S. Cl. CPC B29C 45/2803; B29C 45/1781; B29C 2045/0051; B29C 45/232; B29C 45/80; B29C 45/77

(57) ABSTRACT

An injection molding system including a nozzle member (18) or a valve pin (80) having a tip end (21) wherein the nozzle member (18) or valve pin (80) is adapted to be controllably rotatable around a longitudinal rotation axis (A) to enable an exit aperture (20) of the nozzle or the tip end of the pin to interface with a cavity entrance aperture (30) to controllably vary or adjust size (SP1, SP2) of the cross sectional area (CA) of a gate aperture (50) according to degree of rotation (R) of the nozzle or valve pin around the rotation axis (A).

### RELATED APPLICATIONS

This application is a continuation of PCT Application Serial No. PCT/US2018/025352 filed Mar. 30, 2018, which claims the benefit of priority to U.S. Application Ser. No. 62/479,505 filed Mar. 31, 2017, the disclosures of which are incorporated by reference as if fully set forth in their entirety herein.

The disclosures of all of the following are incorporated by reference in their entirety as if fully set forth herein: U.S. Pat. No. 5,894,025, U.S. Pat. No. 6,062,840, U.S. Pat. No. 6,294,122, U.S. Pat. No. 6,309,208, U.S. Pat. No. 6,287,107, U.S. Pat. No. 6,343,921, U.S. Pat. No. 6,343,922, U.S. Pat. No. 6,254,377, U.S. Pat. No. 6,261,075, U.S. Pat. No. 6,361,300 (7006), U.S. Pat. No. 6,419,870, U.S. Pat. No. 6,464,909 (7031), U.S. Pat. No. 6,599,116, U.S. Pat. No. 7,234,929 (7075US1), U.S. Pat. No. 7,419,625 (7075US2), U.S. Pat. No. 7,569,169 (7075US3), U.S. Pat. No. 8,297,836 (7087) U.S. patent application Ser. No. 10/214,118, filed Aug. 8, 2002 (7006), U.S. Pat. No. 7,029,268 (7077US1), U.S. Pat. No. 7,270,537 (7077US2), U.S. Pat. No. 7,597,828 (7077US3), U.S. patent application Ser. No. 09/699,856 filed Oct. 30, 2000 (7056), U.S. patent application Ser. No. 10/269,927 filed Oct. 11, 2002 (7031), U.S. application Ser. No. 09/503,832 filed Feb. 15, 2000 (7053), U.S. application Ser. No. 09/656,846 filed Sep. 7, 2000 (7060), U.S. application Ser. No. 10/006,504 filed Dec. 3, 2001, (7068), U.S. application Ser. No. 10/101,278 filed Mar. 19, 2002 (7070) and PCT Application No. PCT/US11/062099 (7100WO0) and PCT Application No. PCT/US11/062096 (7100WO1), U.S. Pat. No. 8,562,336, U.S. Pat. No. 8,091,202 (7097US1) and U.S. Pat. No. 8,282,388 (7097US2), U.S. Pat. No. 9,724,861 (7129US4), U.S. Pat. No. 9,662,820 (7129US3), Publication No. WO2015006261 (7135WO0), Publication No. WO2014209857 (7134WO0), Publication No. WO2016153632 (7149WO2), International publication no. WO2016153704 (7149WO4), U.S. Pat. No. 9,205,587 (7117US0), U.S. application Ser. No. 15/432,175 (7117US2) filed Feb. 14, 2017, U.S. Pat. No. 9,144,929 (7118US0), U.S. Publication No. 20170341283 (7118US3), International Application PCT/US17/043029 (7165WO0) filed Jul. 20, 2017, International Application PCT/US17/043100 (7165WO1), filed Jul. 20, 2017 and International Application PCT/US17/036542 (7163WO0) filed Jun. 8, 2017, PCT/US17/061332 filed Nov. 13, 2017 (7167WO0), PCT/US18/012151 (7169WO0) filed Jan. 3, 2018, PCT/US18/017422 (7170WO0) filed Feb. 8, 2018.

### BACKGROUND OF THE INVENTION

Injection molding systems that can control or vary the rate of flow of injection fluid during the course of an injection cycle are known from for example WO2012074879 (A1) (7100WO0) and WO2012087491 (A1) (7100WO1).

### SUMMARY OF THE INVENTION

In accordance with the invention there is provided an injection molding system (5) comprised of an injection molding machine (IMM), a distribution manifold (6) for receiving a selected injection fluid (F) from the injection molding machine (IMM), a valve (10) comprising a flow passage (15) receiving the injection fluid (F) from the manifold (6) having a longitudinal length (L) and a downstream tip end exit aperture (20), a mold (7) having a cavity (60) having a cavity entrance aperture (30), the exit aperture (20) being fluid sealably matable with the cavity entrance aperture (30) to form a gate aperture (50) having a cross sectional area (CA) that has a center (C),

the injection molding machine (IMM) injecting the selected injection fluid (F) to the manifold (6) which distributes the injection fluid for injection downstream through the flow passage (15) of the valve (10) and further downstream to and through the exit aperture (20) and further downstream to and through the gate aperture (50) into the cavity (60) of the mold (7),

the valve (10) including a nozzle member (18) or a valve pin (80) having a tip end (21), the nozzle member (18) or valve pin (80) being adapted to be controllably rotatable around a longitudinal rotation axis (A) to enable the exit aperture (20) or the tip end (21) to interface with the cavity entrance aperture (30) to controllably vary or adjust size (SP1, SP2) of the cross sectional area (CA) of the gate aperture (50) according to degree of rotation (R) of the nozzle member (18) or valve pin (80) around the rotation axis (A).

The center (C) of the gate aperture (50) is preferably radially offset (RO) from the longitudinal rotation axis (A) of the nozzle member (18) or valve pin (80).

The cavity entrance aperture (30) typically has a center (C2) that is radially offset (RO) from the longitudinal rotation axis (A).

The valve (10) preferably includes an actuator (100) interconnected to the nozzle member (18) or valve pin (80) in an arrangement such that the actuator (100) drivably rotates the nozzle member (18) or the valve pin (80) around the longitudinal rotation axis (A).

The actuator (100) can comprise an electric motor or electrically powered device or a hydraulically or pneumatically driven device.

Such a system typically further comprises a controller (110) that includes a program containing instructions that control rate, direction or timing of driven rotation (R) of the nozzle member (18) or valve pin (80) by the actuator (100) during the course of an injection cycle.

The nozzle member (18) can comprises a cylinder (22) having a downstream tip end (22e) in which the exit aperture (20) is formed and a longitudinal rotation axis (A), the elongated cylinder (22) being interconnected to the actuator (100) in an arrangement wherein the elongated cylinder (22) is controllably rotatable (R) around the longitudinal rotation axis (A) by operation of the actuator (100).

The cylinder (22) typically has a central longitudinal bore (15) of which the flow passage is comprised.

The exit aperture (20) preferably has a center (C1) that is radially offset (RO) from the longitudinal rotation axis (a).

The cylinder can be controllably rotatable (R) a selectable degree of rotation around the longitudinal axis (A) to slide the exit aperture (20) over the cross sectional area (CA) of the gate aperture (50) such that the exit aperture (20) communicates with a selectable portion (SP1, SP2) of the cross sectional area (CA) of the gate aperture (50) to form a restricted flow aperture (SP1, SP2) according to degree of rotation (R) wherein flow of injection fluid (F) from the passage (15) into the cavity (60) is restricted relative to a maximum flow that occurs through the cross section (CA) of the gate aperture (50) when the gate aperture (50) is fully open.

The nozzle member (18) or the mold (7) preferably includes a downstream tip or insert member (19) having a longitudinal rotation axis (A) and is rotatably mounted on or to a downstream portion (24) of the nozzle member (18) or to the mold (7) for rotation around the longitudinal rotation axis (A).

The cavity entrance aperture (30) is typically formed in the downstream tip or insert member (19) for rotatable interfacing or communication with the exit aperture (20).

The nozzle member (18) typically includes a fluid delivery cylinder (22) having a downstream tip end (22e) in which the exit aperture (20) is formed in an arrangement wherein a center (C1) of the exit aperture (20) is radially offset (RO) from the longitudinal rotation axis (A).

The nozzle member (18) preferably includes a fluid delivery cylinder (22) having a flow passage (15) and a downstream tip end (22e) in which the exit aperture (20) is formed in an arrangement wherein a center (C1) of the exit aperture (20) is radially offset (RO) from the longitudinal rotation axis (A) and wherein the insert member (19) is controllably rotatable (R) a selectable degree of rotation around the longitudinal axis (A) to slide the cavity entrance aperture (30) over the cross sectional area (CA) of the gate aperture (50) such that the exit aperture (20) communicates with a selectable portion (SP1, SP2) of the cross sectional area (CA) of the gate aperture (50) to form a restricted flow aperture (SP1, SP2) according to degree of rotation (R) wherein flow of injection fluid (F) from the passage (15) into the cavity (60) is restricted relative to a maximum flow that occurs through the cross section (CA) of the gate aperture (50) when the gate aperture (50) is fully open.

The valve pin (80) typically has a pin axis (PA) aligned with the rotational axis (A), the valve pin (80) being interconnected to the actuator (100) such that the valve pin (80) is controllably drivably rotatable around the rotational axis (A) by controllable operation of the actuator.

The valve pin (80) preferably has a tip or distal end surface (21) having a center (CP) that is radially offset (RO) from the rotational axis (A).

The valve pin (80), the tip or distal end surface (21) and the exit aperture (30) are preferably adapted such that the tip or distal end surface (21) of the valve pin (80) is controllably rotatable to slidably obstruct, close or cover over a selectable portion (SP1, SP2) of the exit aperture (30) to create the gate aperture (50), wherein flow of the injection fluid (F) through the gate aperture (50) is restricted according to the selectable degree of rotation and the selectable portion (SP1, SP2) of the cross sectional area (CA) of the gate aperture (50) that is not obstructed, closed or covered over.

In another aspect of the invention there is provided a method of performing an injection cycle comprising injecting a selected injection fluid (F) into a cavity (60) of a mold (7) using a system as described above.

In another aspect of the invention there is provided an injection molding system (5) comprised of an injection molding machine (IMM), a distribution manifold (6) for receiving a selected injection fluid (F) from the injection molding machine (IMM), a valve (10) comprising a flow passage (15) receiving the injection fluid (F) from the manifold (6) having a longitudinal length (L) and a downstream tip end exit aperture (20), a mold (7) having a cavity (60) having a cavity entrance aperture (30), the exit aperture (20) being fluid sealably matable with the cavity entrance aperture (30) to form a gate aperture (50) having a cross sectional area (CA) that has a center (C),

the injection molding machine (IMM) injecting the selected injection fluid (F) to the manifold (6) which distributes the injection fluid for injection downstream through the flow passage (15) of the valve (10) and further downstream to and through the exit aperture (20) and further downstream to and through the gate aperture (50) into the cavity (60) of the mold (7),

the valve (10) including a nozzle member (18) that includes a tip end (22e) in which the exit aperture (20) is diposed, the nozzle member (18) or the mold (7) including a downstream tip or insert member (19),

the insert member (19) including the cavity entrance aperture (30) having a center (C2) radially offset (RO) from a longitudinal rotation axis (A) such that the insert member (19) is controllably rotatable around the longitudinal rotation axis (A) to control interfacing of the cavity entrance aperture (30) with the exit aperture (20) to controllably vary or adjust size (SP1, SP2) of the cross sectional area (CA) of the gate aperture (50) according to degree of rotation (R) of the insert member (19) around the rotation axis (A).

In another aspect of the invention there is provided an injection molding system (5) comprised of an injection molding machine (IMM), a distribution manifold (6) for receiving a selected injection fluid (F) from the injection molding machine (IMM), a valve (10) comprising a flow passage (15) receiving the injection fluid (F) from the manifold (6) having a longitudinal length (L) and a downstream tip end exit aperture (20), a mold (7) having a cavity (60) having a cavity entrance aperture (30), the exit aperture (20) being fluid sealably matable with the cavity entrance aperture (30) to form a gate aperture (50) having a cross sectional area (CA) that has a center (C),

the injection molding machine (IMM) injecting the selected injection fluid (F) to the manifold (6) which distributes the injection fluid for injection downstream through the flow passage (15) of the valve (10) and further downstream to and through the exit aperture (20) and further downstream to and through the gate aperture (50) into the cavity (60) of the mold (7),

the valve (10) including a valve pin (80) having a tip end (21), the valve pin (80) being adapted to be controllably rotatable around a longitudinal rotation axis (A) to enable the tip end (21) to interface with the cavity entrance aperture (30) to controllably vary or adjust size (SP1, SP2) of the cross sectional area (CA) of the gate aperture (50) according to degree of rotation (R) of the nozzle member (18) or valve pin (80) around the rotation axis (A),

the valve pin (80) having a tip or distal end surface (21) having a center (CP) that is radially offset (RO) from the rotational axis (A)

the valve pin (80), the tip or distal end surface (21) and the exit aperture (30) being adapted such that the tip or distal end surface (21) of the valve pin (80) is controllably rotatable around the rotation axis (A) to slidably obstruct, close or cover over a selectable portion (SP1, SP2) of the exit aperture (30) to create the gate aperture (50), wherein flow of the injection fluid (F) through the gate aperture (50) is restricted according to the selectable degree of rotation and the selectable portion (SP1, SP2) of the cross sectional area (CA) of the gate aperture (50) that is not obstructed, closed or covered over.

In an injection molding system (5) comprised of an injection molding machine (IMM), a distribution manifold (6) for receiving a selected injection fluid (F) from the injection molding machine (IMM),

a valve (10) comprising a flow passage (15) receiving the injection fluid (F) from the manifold (6) having a longitudinal length (L) and a downstream tip end exit aperture (20), a mold (7) having a cavity (60) having a cavity entrance aperture (30), the exit aperture (20) being fluid sealably matable with the cavity entrance aperture (30) to form a gate aperture (50) having a cross sectional area (CA) that has a center (C),

the injection molding machine (IMM) injecting the selected injection fluid (F) to the manifold (6) which distributes the injection fluid for injection downstream through the flow passage (15) of the valve (10) and further downstream to and through the exit aperture (20) and further downstream to and through the gate aperture (50) into the cavity (60) of the mold (7),

the valve (10) including a nozzle member (18) or a valve pin (80) having a tip end (21), the nozzle member (18) or valve pin (80) being adapted to be controllably rotatable around a longitudinal rotation axis (A) to enable the exit aperture (20) or the tip end (21) to interface with the cavity entrance aperture (30) to controllably vary or adjust size (SP1, SP2) of the cross sectional area (CA) of the gate aperture (50) according to degree of rotation (R) of the nozzle member (18) or valve pin (80) around the rotation axis (A).

In an injection molding system (5) comprised of an injection molding machine (IMM), a distribution manifold (6) for receiving a selected injection fluid (F) from the injection molding machine (IMM),

a valve (10) comprising a flow passage (15) receiving the injection fluid (F) from the manifold (6) having a longitudinal length (L) and a downstream tip end exit aperture (20), a mold (7) having a cavity (60) having a cavity entrance aperture (30), the exit aperture (20) being fluid sealably matable with the cavity entrance aperture (30) to form a gate aperture (50) having a cross sectional area (CA) that has a center (C),

the injection molding machine (IMM) injecting the selected injection fluid (F) to the manifold (6) which distributes the injection fluid for injection downstream through the flow passage (15) of the valve (10) and further downstream to and through the exit aperture (20) and further downstream to and through the gate aperture (50) into the cavity (60) of the mold (7),

the valve (10) including a nozzle member (18) that includes a tip end (22e) in which the exit aperture (20) is diposed, the nozzle member (18) or the mold (7) including a downstream tip or insert member (19),

the insert member (19) including the cavity entrance aperture (30) having a center (C2) radially offset (RO) from a longitudinal rotation axis (A) such that the insert member (19) is controllably rotatable around the longitudinal rotation axis (A) to control interfacing of the cavity entrance aperture (30) with the exit aperture (20) to controllably vary or adjust size (SP1, SP2) of the cross sectional area (CA) of the gate aperture (50) according to degree of rotation (R) of the insert member (19) around the rotation axis (A).

In an injection molding system (5) comprised of an injection molding machine (IMM), a distribution manifold (6) for receiving a selected injection fluid (F) from the injection molding machine (IMM),

a valve (10) comprising a flow passage (15) receiving the injection fluid (F) from the manifold (6) having a longitudinal length (L) and a downstream tip end exit aperture (20), a mold (7) having a cavity (60) having a cavity entrance aperture (30), the exit aperture (20) being fluid sealably matable with the cavity entrance aperture (30) to form a gate aperture (50) having a cross sectional area (CA) that has a center (C),

the injection molding machine (IMM) injecting the selected injection fluid (F) to the manifold (6) which distributes the injection fluid for injection downstream through the flow passage (15) of the valve (10) and further downstream to and through the exit aperture (20) and further downstream to and through the gate aperture (50) into the cavity (60) of the mold (7),

the valve (10) including a valve pin (80) having a tip end (21), the valve pin (80) being adapted to be controllably rotatable around a longitudinal rotation axis (A) to enable the tip end (21) to interface with the cavity entrance aperture (30) to controllably vary or adjust size (SP1, SP2) of the cross sectional area (CA) of the gate aperture (50) according to degree of rotation (R) of the nozzle member (18) or valve pin (80) around the rotation axis (A),

the valve pin (80) having a tip or distal end surface (21) having a center (CP) that is radially offset (RO) from the rotational axis (A)

the valve pin (80), the tip or distal end surface (21) and the exit aperture (30) being adapted such that the tip or distal end surface (21) of the valve pin (80) is controllably rotatable around the rotation axis (A) to slidably obstruct, close or cover over a selectable portion (SP1, SP2) of the exit aperture (30) to create the gate aperture (50), wherein flow of the injection fluid (F) through the gate aperture (50) is restricted according to the selectable degree of rotation and the selectable portion (SP1, SP2) of the cross sectional area (CA) of the gate aperture (50) that is not obstructed, closed or covered over.

### BRIEF DESCRIPTION OF THE DRAWINGS

Embodiments of the invention are described with reference to the following figures wherein:

FIG. 1 is a side sectional view of an injection molding system according to the invention having a central nozzle rotatable around a rotation axis and a fluid exit aperture radially offset from the rotation axis.

FIG. 2 is s side section close up view of the distal or downstream end of the fluid delivery nozzle and associated mold components.

FIG. 3A is a sectional view along lines 3-3 of FIG. 2 showing the nozzle exit aperture 20 in alignment with the cavity aperture 30 for maximum fluid flow velocity.

FIG. 3B is a sectional view along lines 3-3 of FIG. 2 showing the nozzle exit aperture 20 out of alignment with the cavity aperture 30 to close the aperture 30 such that fluid flow is stopped.

FIG. 4A is a sectional view along lines 4-4 of FIG. 2 showing the nozzle exit aperture 20 in a first partial alignment with the cavity aperture 30.

FIG. 4B is a sectional view along lines 4-4 of FIG. 2 showing the nozzle exit aperture 20 in a second partial alignment with the cavity aperture 30 creating a partially opened gate aperture 50 having a cross sectional area SP2.

FIG. 4C is a sectional view along lines 4-4 of FIG. 2 showing the nozzle exit aperture 20 in a second partial alignment with the cavity aperture 30 creating a partially opened gate aperture 50 having a cross sectional area SP1.

FIG. 5 is a side sectional view of a system similar to the FIG. 1 system instead employing a nozzle having a main nozzle body 22 that is not rotatable with an exit aperture 20 radially offset from a rotation axis of an insert having cavity entrance aperture 30 that is rotatable around the rotation axis for controllable interfacing with the exit aperture.

FIG. 6 is a top perspective view of the downstream end of the FIG. 5 system showing the exit aperture 20 out of alignment with the cavity entrance aperture 30 such that fluid flow is stopped.

FIG. 7 is a top perspective view of the downstream end of the FIG. 5 system showing the exit aperture 20 aligned with the cavity entrance aperture 30 such that fluid flow is at a maximum into the mold cavity.

FIG. 8 a side sectional view of a system similar to the FIG. 1 system instead employing a nozzle having a valve pin that is rotatable with a tip end 21 radially offset from a rotation axis of the pin.

FIG. 9 is a top perspective view of the downstream end of the FIG. 8 system showing the exit aperture 20 out of alignment with the cavity entrance aperture 30 such that fluid flow is stopped.

FIG. 10 is a top perspective view of the downstream end of the FIG. 5 system showing the exit aperture 20 aligned with the cavity entrance aperture 30 such that fluid flow is at a maximum.

FIG. 11 is a sectional view taken along lines 11-11 of FIG. 9.

FIG. 12 is a sectional view taken along lines 12-12 of FIG. 10.

### DETAILED DESCRIPTION OF THE INVENTION

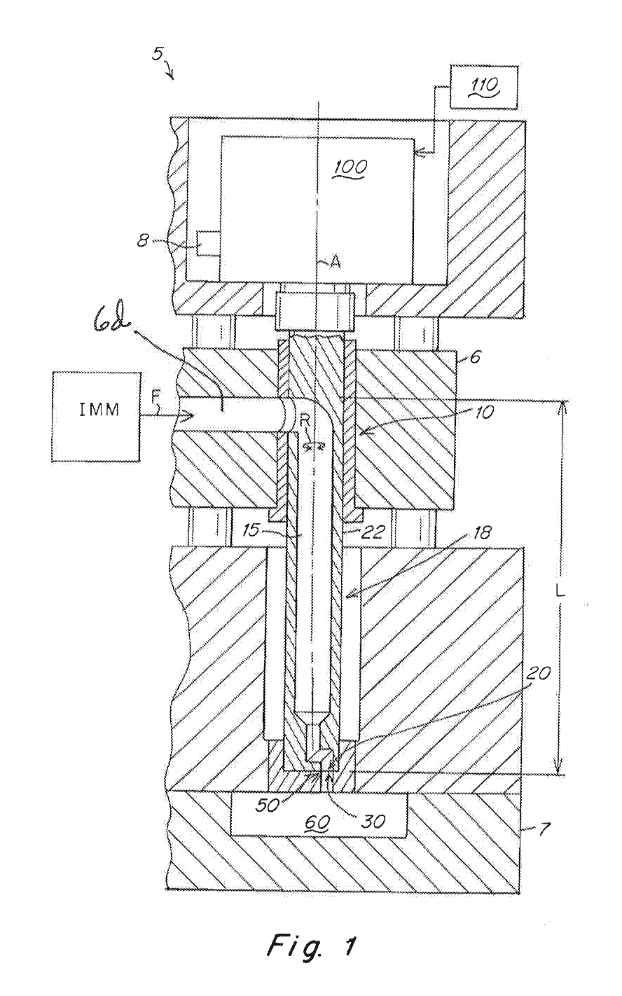

The present invention comprises a valve (10) as described herein as well as an injection molding system (5) as described herein. FIG. 1 illustrates an injection molding system (5) comprised of an injection molding machine (IMM), a distribution manifold (6) that receives a selected injection fluid (F) from the injection molding machine (IMM). The system includes a valve (10) that has a fluid flow passage (15) that receives the injection fluid (F) from the heated manifold (6). The flow passage 15 a longitudinal length (L) and a downstream tip end exit aperture (20) that communicates with a cavity entrance aperture 30. The system includes a mold (7) having a cavity (60) that has an entrance aperture (30). The exit aperture (20) fluid sealably mates with the cavity entrance aperture (30) to form a gate aperture (50) which has a cross sectional area (CA) that has a center (C).

The injection molding machine (IMM) injects the selected injection fluid (F) to a distribution channel 6d of the manifold (6) which distributes the injection fluid F for downstream injection through the flow passage (15) of the valve (10) and further downstream to and through the exit aperture (20) and further downstream to and through the cavity entrance aperture 30 and the gate aperture (50) into the cavity (60) of the mold (7).

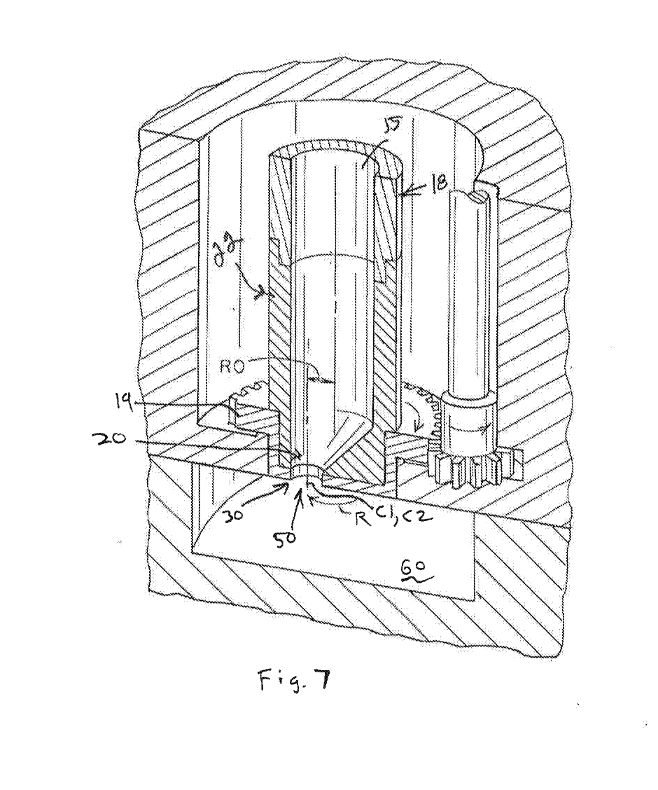

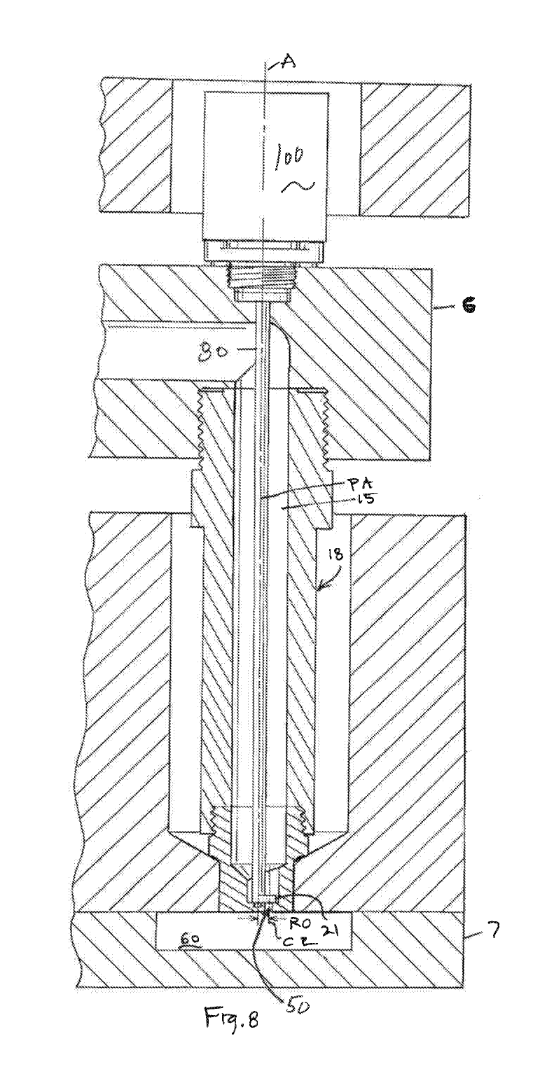

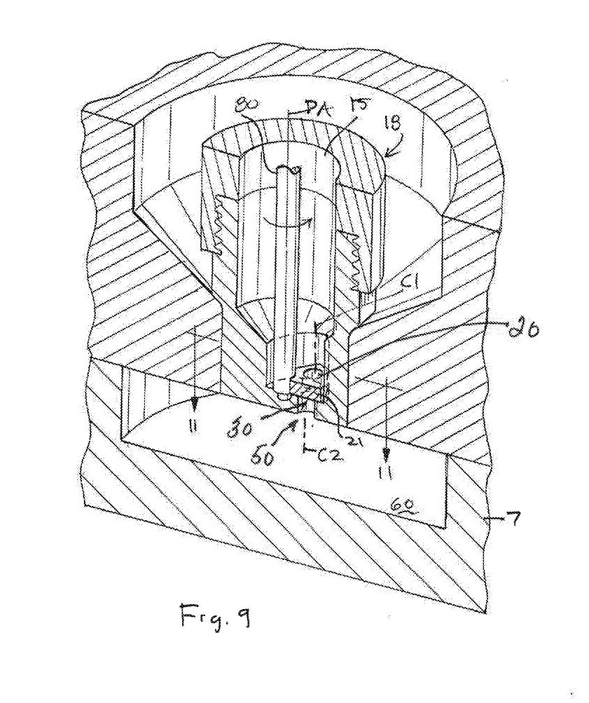

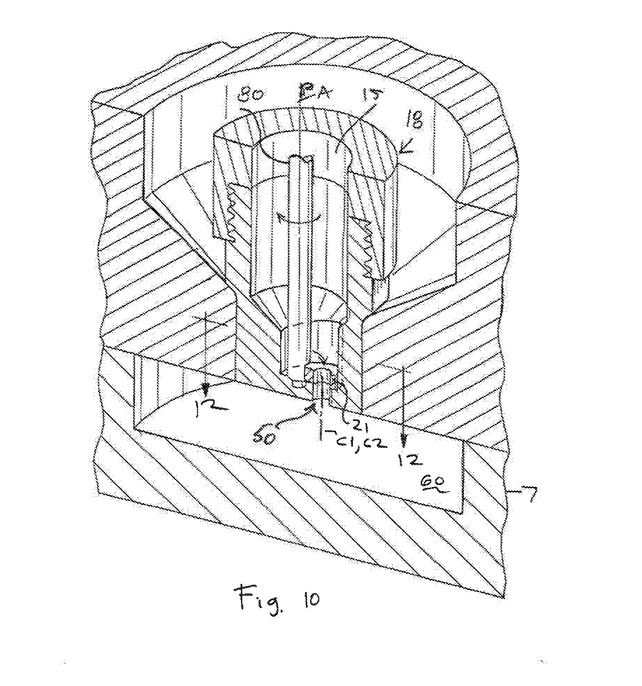

The valve (10) comprises a nozzle member (18), typically a rotatable cylinder having a central flow passage 15 as shown in FIGS. 1-7. Alternatively, as shown in FIGS. 8-12, the nozzle member can comprise a rotatable valve pin (80) disposed within the nozzle passage 15 of a cylindrical nozzle body 18, the valve pin 80 having an off center rotatable tip end (21) that regulates flow through the gate 50. In both such embodiments, the nozzle member (18) or valve pin (80) are adapted to be controllably rotatable around a longitudinal rotation axis (A) to enable the exit aperture (20) or the tip end (21) to interface with the cavity entrance aperture (30) to form a gate aperture 50 that is controllably variable or adjustable in size (SP1, SP2) of the cross sectional area (CA) according to degree of rotation (R) of the nozzle member (18) or valve pin (80) around the rotation axis (A).

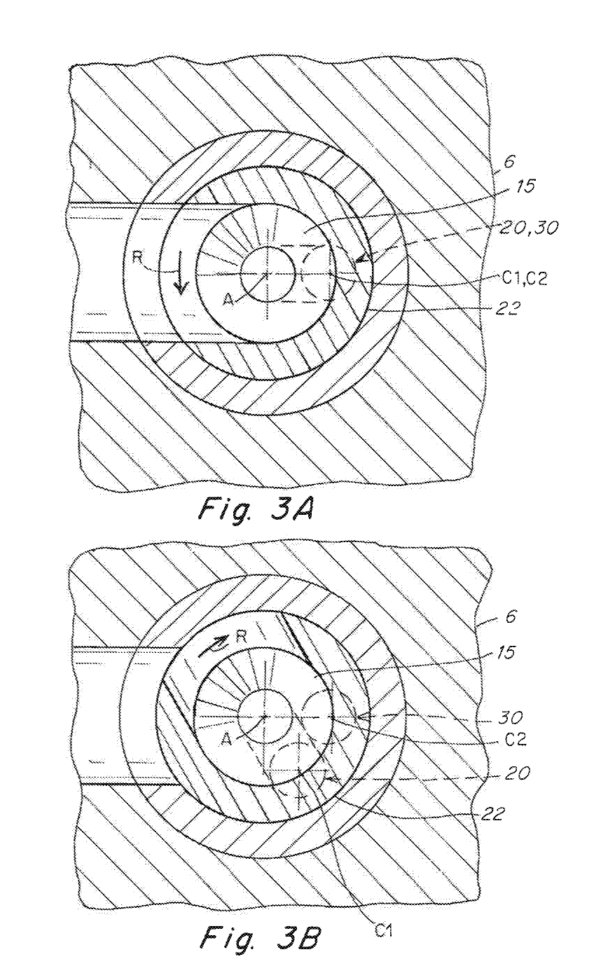

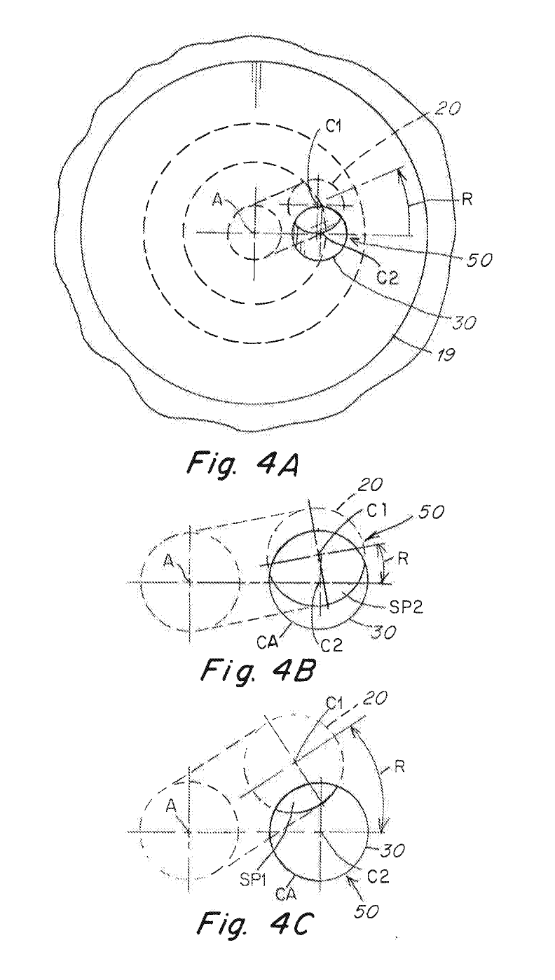

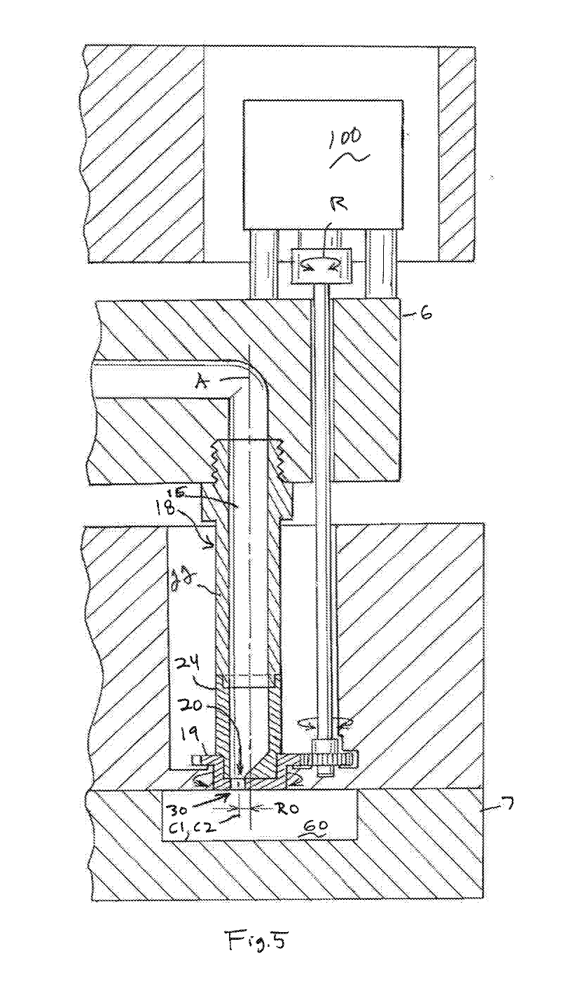

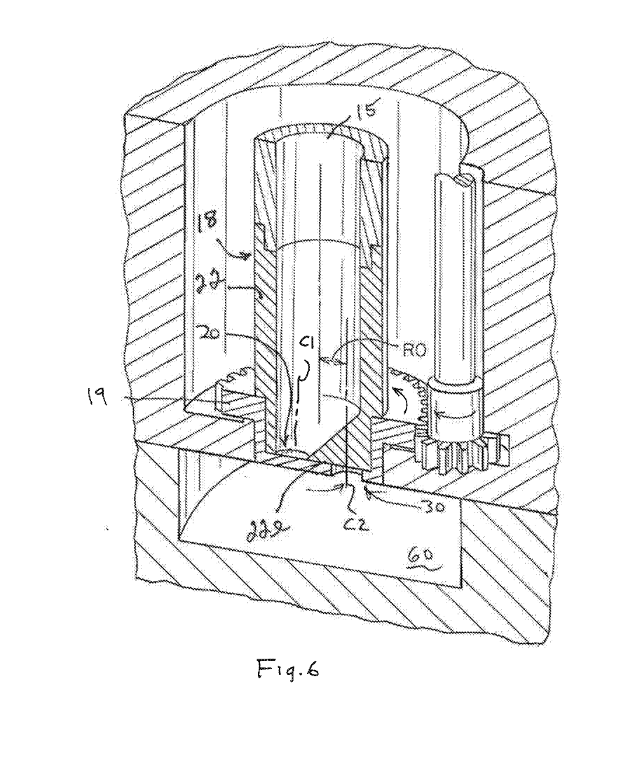

In each of the embodiments shown in FIGS. 1-12, the center (C) of the gate aperture (50) is radially offset (RO) from the longitudinal rotation axis (A) of the nozzle member (18) or valve pin (80) such that as shown in FIGS. 3A, 3B, 4A, 4B, 4C, the size or cross sectional area CA of the gate aperture 50 is either completely open as shown in FIG. 3A, completely closed as shown in FIG. 3B or partially open to a selected degree as shown in FIGS. 4A, 4B, 4C. For example as shown in FIG. 4B, the gate aperture has a partially open gate 50 cross sectional area SP2. And, as shown in FIG. 4C, the gate aperture has a partially open gate 50 cross sectional area SP1

The cavity entrance aperture (30) has a center (C2) that is radially offset (RO) from the longitudinal rotation axis (A), FIGS. 3A-4C.

The valve (10) is controlled by an actuator (100) that is interconnected to the nozzle member (18) or valve pin (80) in an arrangement such that the actuator (100) drivably rotates the nozzle member (18) or the valve pin (80) around the longitudinal rotation axis (A), FIGS. 1, 5, 8. The actuator (100) can comprise an electric motor or electrically powered device or a hydraulically or pneumatically driven device.

A system 5 can include a controller (110) interconnected to the actuator 100, the controller 110 including a program containing instructions that control rate, direction or timing of driven rotation (R) of the actuator 100 and thus also the nozzle member (18) or valve pin (80) during the course of an injection cycle.

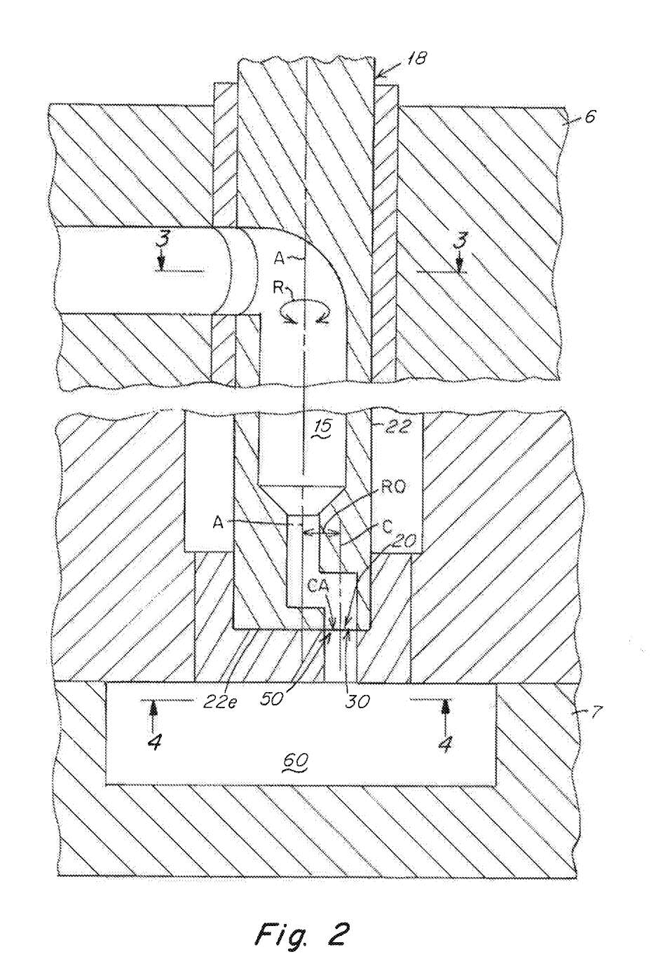

The nozzle member 18 can comprise a cylinder (22), FIGS. 1, 2 having a downstream tip end (22e) in which the exit aperture (20) is formed and a longitudinal rotation axis (A) around which the cylinder is controllably rotatable (R) by operation of the actuator (100). The exit aperture (20) has a center (C1) that is radially offset (RO) from the longitudinal rotation axis A. The cylinder 22 of the FIGS. 1, 2 embodiment is controllably rotatable (R) a selectable degree of rotation around the longitudinal axis (A) to slide the exit aperture (20) over the cross sectional area (CA) of the gate aperture (50) such that the exit aperture (20) communicates with a selectable portion (SP1, SP2) of the cross sectional area (CA) of the gate aperture (50) to form a restricted flow aperture (SP1, SP2) according to degree of rotation (R) wherein flow of injection fluid (F) from the passage (15) into the cavity (60) is restricted relative to a maximum flow that occurs through the cross section (CA) of the gate aperture (50) when the gate aperture (50) is fully open.

Alternatively, FIGS. 5, 6, 7, either the nozzle member (18) or the mold (7) can include a downstream tip or insert member (19) having a longitudinal rotation axis (A) that is rotatably mounted on or to a downstream portion (24) of the nozzle member (18) or to the mold (7) for rotation around the longitudinal rotation axis (A). In such an embodiment, the cavity entrance aperture (30) is formed in the downstream tip or insert member (19) for rotatable interfacing or communication with the exit aperture (20). Further in such an embodiment, the nozzle member (18) can include a fluid delivery cylinder (22) having a downstream tip end (22e) in which the exit aperture (20) is formed in an arrangement wherein a center (C1) of the exit aperture (20) is radially offset (RO) from the longitudinal rotation axis (A).

In the same manner as described above with reference to the FIGS. 1, 2 embodiment, the insert member (19) of the FIGS. 5-8 embodiment is controllably rotatable (R) a selectable degree of rotation around the longitudinal axis (A) to slide the cavity entrance aperture (30) over the cross sectional area (CA) of the gate aperture (50) such that the exit aperture (20) communicates with a selectable portion (SP1, SP2) of the cross sectional area (CA) of the gate aperture (50) to form a restricted flow aperture (SP1, SP2) according to degree of rotation (R), FIGS. 3A, 3B, 4A, 4B, 4C wherein flow of injection fluid (F) from the passage (15) into the cavity (60) is restricted relative to a maximum flow that occurs through the cross section (CA) of the gate aperture (50) when the gate aperture (50) is fully open.

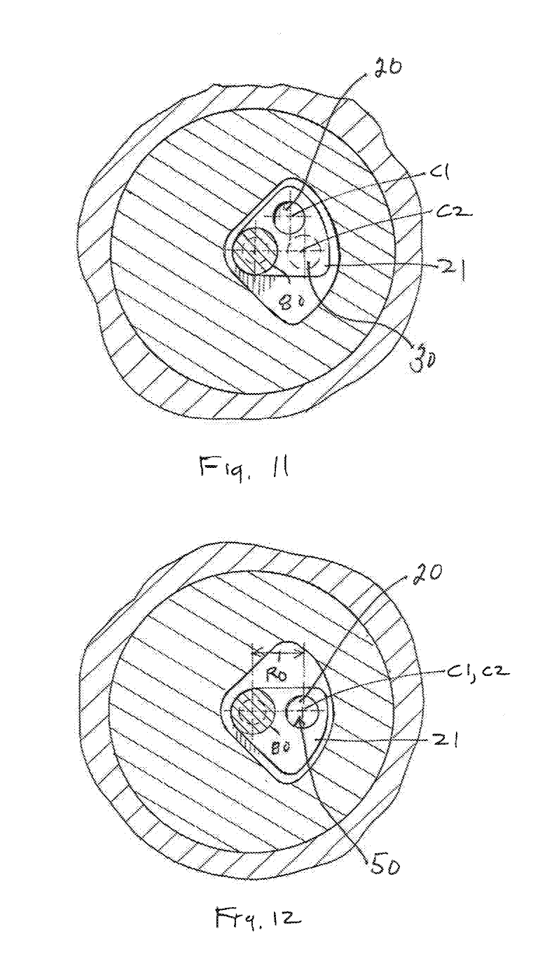

Alternatively as shown in the FIGS. 8-12 embodiment, valve (10) can include a valve pin (80) that has a pin axis (PA) aligned with a pin rotational axis (A), the valve pin (80) being interconnected to an actuator (100) such that the valve pin (80) is controllably drivably rotatable around the rotational axis (A) by controllable operation of the actuator. The valve pin (80) has a tip or distal end surface (21) having a center (CP) that is radially offset (RO) from the rotational axis (A). As shown in FIGS. 11, 12 the tip or distal end surface (21) and the exit aperture (30) are controllably rotatable such that the tip or distal end surface (21) of the valve pin (80) can slidably obstruct, close or cover over a selectable portion (SP1, SP2) of the exit aperture (30) to create the gate aperture (50) such that the flow of the injection fluid (F) through the gate aperture (50) is restricted according to the selectable degree of rotation and the selectable portion (SP1, SP2) of the cross sectional area (CA) of the gate aperture (50) that is not obstructed, closed or covered over.

The invention includes providing a method of performing an injection cycle wherein a selected injection fluid (F) is injected into a cavity (60) of a mold (7) using any of the systems (5) or valves (10) as described herein.

What is claimed is:

1. An injection molding system (5) comprised of an injection molding machine (IMM), a distribution manifold (6) for receiving a selected injection fluid (F) from the injection molding machine (IMM), a valve (10) comprising a flow passage (15) receiving the injection fluid (F) from the manifold (6) having a longitudinal length (L) and a downstream tip end exit aperture (20), a mold (7) having a cavity (60) having a cavity entrance aperture (30), the exit aperture (20) being fluid sealably matable with the cavity entrance aperture (30) to form a gate aperture (50) having a cross sectional area (CA) that has a center (C),
the injection molding machine (IMM) injecting the selected injection fluid (F) to the manifold (6) which distributes the injection fluid for injection downstream through the flow passage (15) of the valve (10) and further downstream to and through the exit aperture (20) and further downstream to and through the gate aperture (50) into the cavity (60) of the mold (7),
the valve (10) including a nozzle member (18) or a valve pin (80) having a tip end (21), the nozzle member (18) or valve pin (80) being adapted to be controllably rotatable around a longitudinal rotation axis (A) to enable the exit aperture (20) or the tip end (21) to interface with the cavity entrance aperture (30) to controllably vary or adjust size (SP1, SP2) of the cross sectional area (CA) of the gate aperture (50) according to degree of rotation (R) of the nozzle member (18) or valve pin (80) around the rotation axis (A).

2. The system of claim 1 wherein the center (C) of the gate aperture (50) is radially offset (RO) from the longitudinal rotation axis (A) of the nozzle member (18) or valve pin (80).

3. A system according to claim 1 wherein the cavity entrance aperture (30) has a center (C2) that is radially offset (RO) from the longitudinal rotation axis (A).

4. A system according to claim 1 wherein the valve (10) includes an actuator (100) interconnected to the nozzle member (18) or valve pin (80) in an arrangement such that the actuator (100) drivably rotates the nozzle member (18) or the valve pin (80) around the longitudinal rotation axis (A).

5. A system according to claim 1 wherein the actuator (100) comprises an electric motor or electrically powered device.

6. A system according to claim 1 wherein the actuator (100) comprises a hydraulically or pneumatically driven device.

7. A system according to claim 1 further comprising a controller (110) that includes a program containing instructions that control rate, direction or timing of driven rotation (R) of the nozzle member (18) or valve pin (80) by the actuator (100) during the course of an injection cycle.

8. A system according to claim 1 wherein the nozzle member (18) comprises a cylinder (22) having a downstream tip end (22e) in which the exit aperture (20) is formed and a longitudinal rotation axis (A), the elongated cylinder (22) being interconnected to the actuator (100) in an arrangement wherein the elongated cylinder (22) is controllably rotatable (R) around the longitudinal rotation axis (A) by operation of the actuator (100).

9. A system according to claim 8 wherein the cylinder (22) has a central longitudinal bore (15) of which the flow passage is comprised.

10. A system according to claim 8 wherein the exit aperture (20) has a center (C1) that is radially offset (RO) from the longitudinal rotation axis (a).

11. A system according to claim 8 wherein the cylinder is controllably rotatable (R) a selectable degree of rotation around the longitudinal axis (A) to slide the exit aperture (20) over the cross sectional area (CA) of the gate aperture (50) such that the exit aperture (20) communicates with a selectable portion (SP1, SP2) of the cross sectional area (CA) of the gate aperture (50) to form a restricted flow aperture (SP1, SP2) according to degree of rotation (R) wherein flow of injection fluid (F) from the passage (15) into the cavity (60) is restricted relative to a maximum flow that occurs through the cross section (CA) of the gate aperture (50) when the gate aperture (50) is fully open.

12. A system according to claim 1 wherein the nozzle member (18) or the mold (7) includes a downstream tip or insert member (19) having a longitudinal rotation axis (A) and is rotatably mounted on or to a downstream portion (24) of the nozzle member (18) or to the mold (7) for rotation around the longitudinal rotation axis (A).

13. A system according to claim 12 wherein the cavity entrance aperture (30) is formed in the downstream tip or insert member (19) for rotatable interfacing or communication with the exit aperture (20).

14. A system according to claim 12 wherein the nozzle member (18) includes a fluid delivery cylinder (22) having a downstream tip end (22e) in which the exit aperture (20) is formed in an arrangement wherein a center (C1) of the exit aperture (20) is radially offset (RO) from the longitudinal rotation axis (A).

15. A system according to claim 13 wherein the nozzle member (18) includes a fluid delivery cylinder (22) having a flow passage (15) and a downstream tip end (22e) in which the exit aperture (20) is formed in an arrangement wherein a center (C1) of the exit aperture (20) is radially offset (RO) from the longitudinal rotation axis (A) and wherein the insert member (19) is controllably rotatable (R) a selectable degree of rotation around the longitudinal axis (A) to slide the cavity entrance aperture (30) over the cross sectional area (CA) of the gate aperture (50) such that the exit aperture (20) communicates with a selectable portion (SP1, SP2) of the cross sectional area (CA) of the gate aperture (50) to form a restricted flow aperture (SP1, SP2) according to degree of rotation (R) wherein flow of injection fluid (F) from the passage (15) into the cavity (60) is restricted relative to a maximum flow that occurs through the cross section (CA) of the gate aperture (50) when the gate aperture (50) is fully open.

16. A system according to claim 1 wherein the valve pin (80) has a pin axis (PA) aligned with the rotational axis (A), the valve pin (80) being interconnected to the actuator (100) such that the valve pin (80) is controllably drivably rotatable around the rotational axis (A) by controllable operation of the actuator.

17. A system according to claim 16 wherein the valve pin (80) has a tip or distal end surface (21) having a center (CP) that is radially offset (RO) from the rotational axis (A).

18. A system according to claim 16 wherein the valve pin (80), the tip or distal end surface (21) and the exit aperture (30) are adapted such that the tip or distal end surface (21) of the valve pin (80) is controllably rotatable to slidably obstruct, close or cover over a selectable portion (SP1, SP2) of the exit aperture (30) to create the gate aperture (50), wherein flow of the injection fluid (F) through the gate aperture (50) is restricted according to the selectable degree of rotation and the selectable portion (SP1, SP2) of the cross sectional area (CA) of the gate aperture (50) that is not obstructed, closed or covered over.

19. A method of performing an injection cycle comprising injecting a selected injection fluid (F) into a cavity (60) of a mold (7) using a system according to claim 1.

20. An injection molding system (5) comprised of an injection molding machine (IMM), a distribution manifold (6) for receiving a selected injection fluid (F) from the injection molding machine (IMM), a valve (10) comprising a flow passage (15) receiving the injection fluid (F) from the manifold (6) having a longitudinal length (L) and a downstream tip end exit aperture (20), a mold (7) having a cavity (60) having a cavity entrance aperture (30), the exit aperture (20) being fluid sealably matable with the cavity entrance aperture (30) to form a gate aperture (50) having a cross sectional area (CA) that has a center (C),
the injection molding machine (IMM) injecting the selected injection fluid (F) to the manifold (6) which distributes the injection fluid for injection downstream through the flow passage (15) of the valve (10) and further downstream to and through the exit aperture (20) and further downstream to and through the gate aperture (50) into the cavity (60) of the mold (7),
the valve (10) including a nozzle member (18) that includes a tip end (22e) in which the exit aperture (20) is diposed, the nozzle member (18) or the mold (7) including a downstream tip or insert member (19),
the insert member (19) including the cavity entrance aperture (30) having a center (C2) radially offset (RO) from a longitudinal rotation axis (A) such that the insert member (19) is controllably rotatable around the longitudinal rotation axis (A) to control interfacing of the cavity entrance aperture (30) with the exit aperture (20) to controllably vary or adjust size (SP1, SP2) of the cross sectional area (CA) of the gate aperture (50) according to degree of rotation (R) of the insert member (19) around the rotation axis (A).

21. An injection molding system (5) comprised of an injection molding machine (IMM), a distribution manifold (6) for receiving a selected injection fluid (F) from the injection molding machine (IMM), a valve (10) comprising a flow passage (15) receiving the injection fluid (F) from the manifold (6) having a longitudinal length (L) and a downstream tip end exit aperture (20), a mold (7) having a cavity (60) having a cavity entrance aperture (30), the exit aperture (20) being fluid sealably matable with the cavity entrance aperture (30) to form a gate aperture (50) having a cross sectional area (CA) that has a center (C),
the injection molding machine (IMM) injecting the selected injection fluid (F) to the manifold (6) which distributes the injection fluid for injection downstream through the flow passage (15) of the valve (10) and further downstream to and through the exit aperture (20) and further downstream to and through the gate aperture (50) into the cavity (60) of the mold (7),
the valve (10) including a valve pin (80) having a tip end (21), the valve pin (80) being adapted to be controllably rotatable around a longitudinal rotation axis (A) to enable the tip end (21) to interface with the cavity entrance aperture (30) to controllably vary or adjust size (SP1, SP2) of the cross sectional area (CA) of the gate aperture (50) according to degree of rotation (R) of the nozzle member (18) or valve pin (80) around the rotation axis (A),
the valve pin (80) having a tip or distal end surface (21) having a center (CP) that is radially offset (RO) from the rotational axis (A)
the valve pin (80), the tip or distal end surface (21) and the exit aperture (30) being adapted such that the tip or distal end surface (21) of the valve pin (80) is controllably rotatable around the rotation axis (A) to slidably obstruct, close or cover over a selectable portion (SP1, SP2) of the exit aperture (30) to create the gate aperture (50), wherein flow of the injection fluid (F) through the gate aperture (50) is restricted according to the selectable degree of rotation and the selectable portion (SP1, SP2) of the cross sectional area (CA) of the gate aperture (50) that is not obstructed, closed or covered over.

22. In an injection molding system (5) comprised of an injection molding machine (IMM), a distribution manifold (6) for receiving a selected injection fluid (F) from the injection molding machine (IMM),
a valve (10) comprising a flow passage (15) receiving the injection fluid (F) from the manifold (6) having a longitudinal length (L) and a downstream tip end exit aperture (20), a mold (7) having a cavity (60) having a cavity entrance aperture (30), the exit aperture (20) being fluid sealably matable with the cavity entrance aperture (30) to form a gate aperture (50) having a cross sectional area (CA) that has a center (C),
the injection molding machine (IMM) injecting the selected injection fluid (F) to the manifold (6) which distributes the injection fluid for injection downstream through the flow passage (15) of the valve (10) and further downstream to and through the exit aperture (20) and further downstream to and through the gate aperture (50) into the cavity (60) of the mold (7),
the valve (10) including a nozzle member (18) or a valve pin (80) having a tip end (21), the nozzle member (18) or valve pin (80) being adapted to be controllably rotatable around a longitudinal rotation axis (A) to enable the exit aperture (20) or the tip end (21) to interface with the cavity entrance aperture (30) to controllably vary or adjust size (SP1, SP2) of the cross sectional area (CA) of the gate aperture (50) according to degree of rotation (R) of the nozzle member (18) or valve pin (80) around the rotation axis (A).

23. In an injection molding system (5) comprised of an injection molding machine (IMM), a distribution manifold (6) for receiving a selected injection fluid (F) from the injection molding machine (IMM),
a valve (10) comprising a flow passage (15) receiving the injection fluid (F) from the manifold (6) having a longitudinal length (L) and a downstream tip end exit aperture (20), a mold (7) having a cavity (60) having a cavity entrance aperture (30), the exit aperture (20) being fluid sealably matable with the cavity entrance aperture (30) to form a gate aperture (50) having a cross sectional area (CA) that has a center (C),
the injection molding machine (IMM) injecting the selected injection fluid (F) to the manifold (6) which distributes the injection fluid for injection downstream through the flow passage (15) of the valve (10) and further downstream to and through the exit aperture (20) and further downstream to and through the gate aperture (50) into the cavity (60) of the mold (7),
the valve (10) including a nozzle member (18) that includes a tip end (22e) in which the exit aperture (20) is diposed, the nozzle member (18) or the mold (7) including a downstream tip or insert member (19),
the insert member (19) including the cavity entrance aperture (30) having a center (C2) radially offset (RO) from a longitudinal rotation axis (A) such that the insert member (19) is controllably rotatable around the longitudinal rotation axis (A) to control interfacing of the cavity entrance aperture (30) with the exit aperture (20) to controllably vary or adjust size (SP1, SP2) of the cross sectional area (CA) of the gate aperture (50) according to degree of rotation (R) of the insert member (19) around the rotation axis (A).

24. In an injection molding system (5) comprised of an injection molding machine (IMM), a distribution manifold (6) for receiving a selected injection fluid (F) from the injection molding machine (IMM),
a valve (10) comprising a flow passage (15) receiving the injection fluid (F) from the manifold (6) having a longitudinal length (L) and a downstream tip end exit aperture (20), a mold (7) having a cavity (60) having a cavity entrance aperture (30), the exit aperture (20) being fluid sealably matable with the cavity entrance aperture (30) to form a gate aperture (50) having a cross sectional area (CA) that has a center (C),
the injection molding machine (IMM) injecting the selected injection fluid (F) to the manifold (6) which distributes the injection fluid for injection downstream through the flow passage (15) of the valve (10) and further downstream to and through the exit aperture (20) and further downstream to and through the gate aperture (50) into the cavity (60) of the mold (7),
the valve (10) including a valve pin (80) having a tip end (21), the valve pin (80) being adapted to be controllably rotatable around a longitudinal rotation axis (A) to enable the tip end (21) to interface with the cavity entrance aperture (30) to controllably vary or adjust size (SP1, SP2) of the cross sectional area (CA) of the gate aperture (50) according to degree of rotation (R) of the nozzle member (18) or valve pin (80) around the rotation axis (A),
the valve pin (80) having a tip or distal end surface (21) having a center (CP) that is radially offset (RO) from the rotational axis (A)
the valve pin (80), the tip or distal end surface (21) and the exit aperture (30) being adapted such that the tip or distal end surface (21) of the valve pin (80) is controllably rotatable around the rotation axis (A) to slidably obstruct, close or cover over a selectable portion (SP1, SP2) of the exit aperture (30) to create the gate aperture (50), wherein flow of the injection fluid (F) through the gate aperture (50) is restricted according to the selectable degree of rotation and the selectable portion (SP1, SP2) of the cross sectional area (CA) of the gate aperture (50) that is not obstructed, closed or covered over.
